(19) United States
(12) Patent Application Publication
(10) Pub. No.: US 2008/0246966 A1
(43) Pub. Date: Oct. 9, 2008

(54) Surface-Inspecting Apparatus and Surface-Inspecting Method

(75) Inventors: Takeo Oomori, Hachioji-shi (JP); Kazuhiko Fukazawa, Kamakura-shi (JP); Hideo Hirose, Shiraokamachi (JP)

Correspondence Address: OLIFF & BERRIDGE, PLC, P.O. BOX 320850, ALEXANDRIA, VA, 22320-4850, US

(73) Assignee: Nikon Corporation, Tokyo (JP)

(21) Appl. No.: 11/918,073

(22) PCT Filed: Nov. 29, 2006
(86) PCT No.: PCT/JP2006/323833

§ 371 Date: Oct. 9, 2007

(30) Foreign Application Priority Data
Dec. 14, 2005 (JP) 2005-360507

(51) Int. Cl. G01J 4/00; G01N 21/55

(52) U.S. Cl. 356/364; 356/445

(57) ABSTRACT

Defect inspection of repeated pattern on a surface is executed by reducing influence of a base layer. Thus, surface-inspecting apparatus and method include unit irradiating repeated pattern on specimen's surface with illuminating light, units setting an angle formed by direction on an incidence plane's surface including irradiating direction of illuminating light and a normal to the surface and repeated direction of repeated pattern to predetermined value except zero, a light detecting unit detecting regular reflected light from repeated pattern when illuminating light is irradiated and outputs information about light intensity of regular reflected light, and a detecting unit detecting the repeated pattern's defect on information, from light detecting unit. Additionally, an angle formed by the direction on incidence plane's surface and repeated direction, an angle formed by irradiating direction of illuminating light and normal to surface, a wavelength of illuminating light, and a pitch of repeated pattern satisfy conditional expression.

### TECHNICAL FIELD

The present invention relates to a surface-inspecting apparatus and a surface-inspecting method for carrying out defect inspection of a repeated pattern formed on a surface of a specimen.

### BACKGROUND ART

An apparatus is known, which irradiates a repeated pattern formed on a surface of a specimen (for example, a semiconductor wafer, a liquid crystal substrate, etc.) with illuminating light for inspection and carries out defect inspection of the repeated pattern based on diffracted light emitted from the repeated pattern (for example, refer to Patent Document 1).

Patent Document 1: Japanese Unexamined Patent Application Publication No. Hei-10-232122

### DISCLOSURE OF THE INVENTION

### Problems to Resolved by the Invention

However, there may be the case where a repeated pattern is also formed in a base layer of a specimen, such as a semiconductor wafer, the pitch of which is about the same as that of a repeated pattern on its surface. Because of this, in the above-mentioned defect inspection using diffracted light, there may be the case where the defect inspection of a repeated pattern on the surface to be inspected cannot be carried out successfully because the diffracted light (signal light) emitted from the repeated pattern on the surface is mixed with the diffracted light (noise light) emitted from the repeated pattern in the base layer.

An object of the present invention is to provide a surface-inspecting apparatus and a surface-inspecting method capable of successfully carrying out defect inspection of a repeated pattern on a surface by reducing the influence of a base layer.

### Means for Solving the Problems

A surface-inspecting apparatus of the present invention includes: an irradiating unit that irradiates a repeated pattern formed on a surface of a specimen with illuminating light; a setting unit that sets an angle formed by a direction on the surface of an incidence plane including an irradiating direction of the illuminating light and a normal to the surface and a repeated direction of the repeated pattern to a predetermined value other than zero; a light detecting unit that detects regular reflected light emitted from the repeated pattern when the illuminating light is irradiated and outputs information about light intensity of the regular reflected light; and a detecting unit that detects a defect of the repeated pattern based on information about the light intensity of the regular reflected light, output from the light detecting unit, wherein an angle φ formed by the direction on the surface of the incidence plane and the repeated direction, an angle θ formed by the irradiating direction of the illuminating light and the normal to the surface, a wavelength λ of the illuminating light, and a pitch p of the repeated pattern satisfy the following conditional expression.

λ/[2 cos(θ·sin φ)]>p

In addition, it is preferable for the illuminating light to include light having a plurality of different wavelengths.

It is also preferable to include an adjusting unit that adjusts the light intensity of each wavelength of the illuminating light in accordance with the wavelength characteristic of the sensitivity of the light detecting unit.

It is also preferable to include an extracting unit arranged on at least one of light paths of the irradiating unit and the light detecting unit to extract a predetermined polarized component.

In addition, it is preferable to include a first rotating unit that rotates the specimen around an axis perpendicular to the surface.

It is also preferable to include a second rotating unit that rotates at least two of the light irradiating unit, the light detecting unit, and the specimen around an axis perpendicular to the incidence plane and included in the surface.

A surface-inspecting method of the present invention irradiates a repeated pattern formed on a surface of a specimen with illuminating light, detects regular reflected light emitted from the repeated pattern when the illuminating light is irradiated, and detects a defect of the repeated pattern based on information about light intensity of the regular reflected light, wherein: an angle formed by a direction on the surface of an incidence plane including the irradiating direction of the illuminating light and a normal to the surface and the repeated direction of the repeated pattern is set to a predetermined value other than zero; and an angle φ formed by the direction on the surface of the incidence plane and the repeated direction, an angle θ formed by an irradiating direction of the illuminating light and a normal to the surface, a wavelength λ of the illuminating light, and a pitch p of the repeated pattern satisfy the following conditional expression.

λ/[2 cos(θ·sin φ)]>p

According to the surface-inspecting apparatus and the surface-inspecting method of the present invention, it is possible to successfully carry out defect inspection of a repeated pattern on a surface by reducing the influence of a base layer.

### BRIEF DESCRIPTION OF THE DRAWINGS

FIG. 1 is a diagram showing a general configuration of a surface-inspecting apparatus 10 in a first embodiment;

FIG. 2 is an outside appearance of a surface of a semiconductor wafer 20;

FIG. 3 is a perspective view that illustrates a concave and convex structure of a repeated pattern 22;

FIG. 4 is a diagram that illustrates a tilted state of an incidence plane (3A) of illuminating light L1 and a repeated direction of the repeated pattern 22 (X direction);

FIG. 5 is a diagram that illustrates a vibrating plane of linear-polarized components L5, L6 and a repeated direction of layers when explaining a mechanical birefringence of vertical incidence;

FIG. 6 is a diagram showing a relationship between a refractive index and thickness t₁ of substance 1 when explaining the mechanical birefringence of vertical incidence;

FIG. 7 is a diagram showing a relationship between a reflectance and thickness t₁ of substance 1;

FIG. 8 is a diagram that illustrates a changing mechanism of a wavelength-selective filter;

FIG. 9 is a diagram showing an example of a bright-line spectrum included in light from a light source 31;

FIG. 10 is a diagram showing a wavelength characteristic of sensitivity of an image sensor 37;

FIG. 11 is a diagram that illustrates spectral intensity (before correction) of each wavelength of illuminating light L1;

FIG. 12 is a diagram that illustrates effective intensity (before correction) after the image sensor 37 has detected light;

FIG. 13 is a diagram showing an example of spectral transmittance of a wavelength-selective filter 32; and

FIG. 14 is a diagram that illustrates the effective intensity (after correction) after the image sensor 37 has received light.

### BEST MODE FOR CARRYING OUT THE INVENTION

Embodiments of the present invention will be described below in detail using the drawings.

### First Embodiment

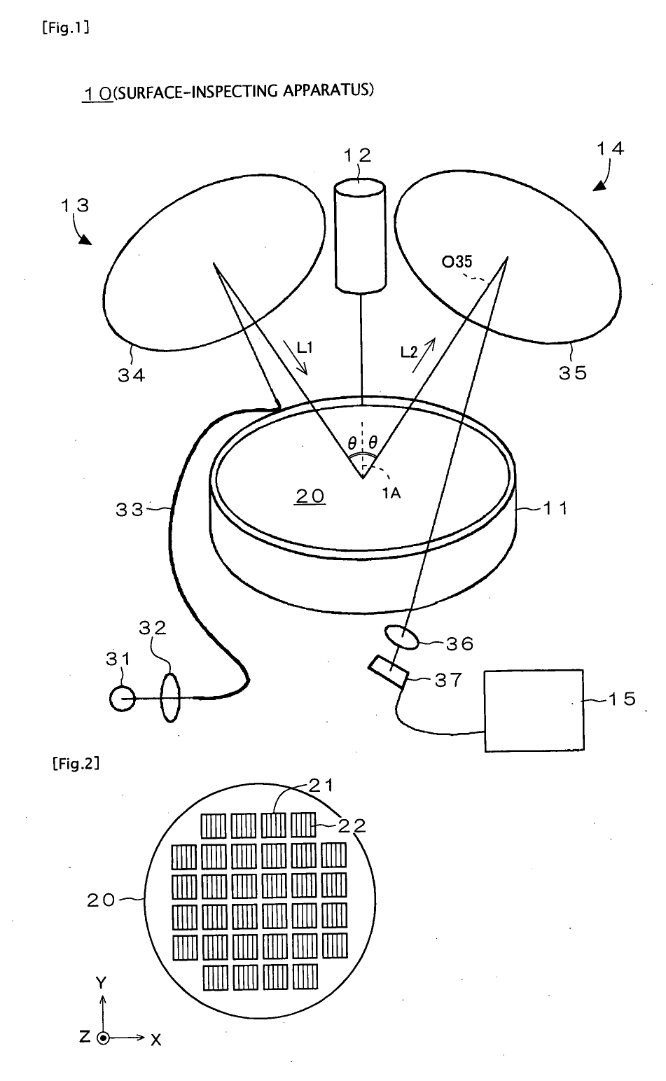

A surface-inspecting apparatus 10 in a first embodiment includes, as shown in FIG. 1, a stage 11 that supports a specimen 20, an alignment system 12, an illuminating system 13, a light detecting system 14, and an image processing unit 15. The illuminating system 13 has a light source 31, a wavelength-selective filter 32, a light guiding fiber 33, and a concave reflecting mirror 34. The light detecting system 14 has a concave reflecting mirror 35 similar to the concave reflecting mirror 34, an image-forming lens 36, and an image sensor 37.

The specimen 20 is, for example, a semiconductor wafer, a liquid crystal glass substrate, etc. On the surface (resist layer) of the specimen 20, a plurality of shot areas 21 is arranged as shown in FIG. 2, and in each shot area 21, a repeated pattern 22 to be inspected is formed. The repeated pattern 22 is a pattern of line and space, such as a wiring pattern, and as shown in FIG. 3, a plurality of line parts 2A is arranged at a fixed pitch p along its short length direction (X direction). Between neighboring line parts 2A, a space part 2B is formed. The array direction (X direction) of the line parts 2A is referred to as a “repeated direction of the repeated pattern 22”.

The surface-inspecting apparatus 10 of the first embodiment is an apparatus that automatically carries out the defect inspection of the repeated pattern 22 formed on the surface of the specimen 20 in the manufacturing process of a semiconductor circuit element and a liquid crystal display element. In the surface-inspecting apparatus 10, the specimen 20 the surface (resist layer) of which has been subjected to exposure and development is brought from a cassette or a developing machine by a transfer system, not shown, and is adsorbed to the stage 11.

A defect in the repeated pattern 22 is a change in the structure of the repeated pattern 22 (that is, a duty ratio or cross sectional shape) corresponding to a change in line width D_{A} of the line part 2A (or a change in line width D_{B} of the space part 2B) shown in FIG. 3. Even if line widths D_{A}, D_{B} change, the pitch p remains the same. Such a defect results from a shift in the exposure focus when the repeated pattern 22 is formed and appears in each shot area 21 of the specimen 20.

The stage 11 places the specimen 20 on its top surface and fixes and holds it by vacuum adsorption. Further, the top surface of the stage 11 is a horizontal surface and not having a tilting mechanism. Due to this, the specimen 20 is kept in a horizontal state. Furthermore, the stage 11 is provided with a mechanism that rotates the specimen 20 around an axis (for example, a normal 1A at the center of the surface) perpendicular to the surface of the specimen 20. By means of the rotating mechanism, it is possible to rotate the repeated direction (X direction in FIG. 2, FIG. 3) of the repeated pattern 22 of the specimen 20 in the surface of the specimen 20.

The illuminating system 13 (FIG. 1) irradiates the repeated pattern 22 (FIG. 2, FIG. 3) formed on the surface of the specimen 20 with unpolarized illuminating light Li. The light source 31 is an inexpensive radial light source, such as a metal halide lamp, a mercury lamp, etc. The wavelength-selective filter 32 selectively transmits a bright-line spectrum having a predetermined wavelength among the light from the light source 31. The light guiding fiber 33 transfers the light from the wavelength-selective filter 32. The concave reflecting mirror 34 is a reflecting mirror using the inner side of its spherical surface as a reflecting plane, and is arranged so that the front focus substantially coincides with an emission end of the light guiding fiber 33 and the rear focus substantially coincides with the surface of the specimen 20. The illuminating system 13 is an optical system telecentric to the side of the specimen 20.

In the illuminating system 13, the light from the light source 31 passes through the wavelength-selective filter 32, the light guiding fiber 33, and the concave reflecting mirror 34 to be turned into the unpolarized illuminating light L1, and then enters the entire surface of the specimen 20 in an oblique direction. The incidence angle of the illuminating light L1 is substantially the same at each point on the surface of the specimen 20, corresponding to an angle θ formed by the normal at each point on the surface (in FIG. 1, a normal 1A at the center of the surface is shown) and the irradiating direction of the illuminating light L1.

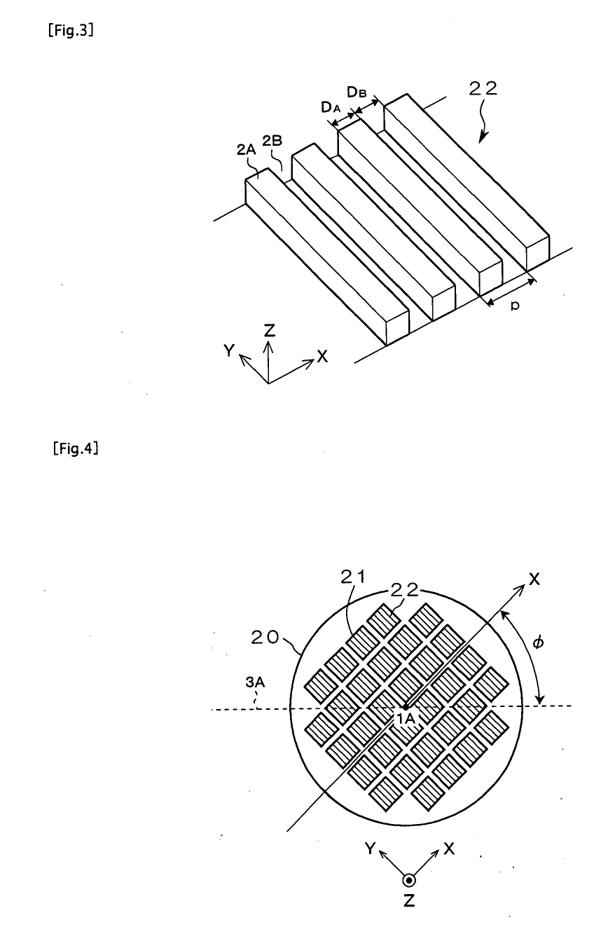

When the repeated pattern 22 on the surface of the specimen 20 is illuminated with the unpolarized illuminating light L1 (incidence angle θ), the repeated direction (X direction) of the repeated pattern 22 is set as follows for an incidence plane 3A (FIG. 4) including the irradiating direction of the illuminating light L1 and the normal 1A to the surface. In other words, an angle φ formed by the direction on the surface of the incidence plane 3A and the repeated direction (X direction) is set obliquely (0 degree<φ<90 degrees). The angle φ is, for example, 45 degrees.

The setting of such an angle φ is carried out using the rotating mechanism of the stage 11 and the alignment system 12. While rotating the specimen 20 about the normal 1A as its axis by the stage 11, the outer edge part of the specimen 20 is illuminated by the alignment system 12, the position of the rotating direction of an outline reference (for example, a notch) provided at the outer edge part is detected, and the stage 11 is stopped at a predetermined position. Due to such an alignment, it is possible to set the angle φ (hereinafter, referred to as a “rotation angle φ”) obliquely.

Further, when the rotation angle φ is set obliquely and the repeated pattern 22 on the surface of the specimen 20 is illuminated with the unpolarized illuminating light L1 (incidence angle θ) as described above, the rotation angle φ, the incidence angle θ of the illuminating light L1, and the wavelength λ of the illuminating light L1 are set so as to satisfy the following conditional expression (1) in accordance with the pitch p of the repeated pattern 22.

λ/[2 cos(θ·sin φ)]>p . . . (1)

The conditional expression (1) is a conditional expression that prevents the diffracted light from being emitted from the repeated pattern 22 when the illuminating light L1 is irradiated. When the rotation angle φ, the incidence angle θ, the wavelength λ, and the pitch p satisfy the conditional expression (1), the diffracted light is not included in the light emitted from the repeated pattern 22 and therefore it is not possible to carry out the defect inspection of the repeated pattern 22 using the diffracted light. The surface-inspecting apparatus 10 in the present embodiment carries out the defect inspection of the repeated pattern 22 using regular reflected light L2 emitted from the repeated pattern 22.

Here, the derivation of the conditional expression (1) is explained briefly.

A general expression of diffraction is expressed by the following expression (2) using the incidence angle θ of the illuminating light, the diffraction angle d of the illuminating light, the diffraction order m of the illuminating light, the pitch p of the repeated pattern 22, and the wavelength λ when the rotation angle φ is 0 degree,

sin d−sin θ=mλ/p . . . (2).

Then, when the angle φ is not zero, the illuminating light and the diffracted light are projected on the plane (main cross section) including the repeated direction of the repeated pattern 22 and the normal 1A of the specimen 20 and the following expression (3) holds using an incidence angle θ and a diffraction angle d′ of the illuminating light projected on the main cross section. The (θ·sin φ) on the right-hand side of the expression corresponds to a tilt angle of the illuminating light for the main cross section.

sin d′−sin θ′=mλ/p cos (θ·sin φ) . . . (3)

In expression (3), the range that diffraction angle d′ assumes is −90 degrees≦d′≦90 degrees. The range the incidence angle θ′ assumes is 0 degree≦θ′≦90 degrees. Because of this, the minimum value of the left-hand side (=sin d′−sin θ′) of expression (3) is −2 and under the condition that the left-hand side is −2 or more, the diffracted light will be emitted from the repeated pattern 22.

On the other hand, under the condition that the left-hand side (=sin d′−sin θ′) is less than −2, no diffracted light will be emitted from the repeated pattern 22. The diffraction order of the diffracted light that is emitted when the left-hand side is −2 is negative order m, and therefore, the condition that no diffracted light will be emitted from the repeated pattern 22 can be thought the condition that the diffracted light the diffraction order of which is −1 will not be emitted. Then, by substituting −1 for the diffraction order m on the right-hand side of expression (3) and considering the condition that the left-hand side (=sin d′−sin θ′) is less than −2, it is possible to obtain the conditional expression (1) described above.

Combinations of the parameters (incidence angle θ, rotation angle φ, wavelength λ, pitch p) that satisfy the conditional expression (1) are exemplified below. For example, when the incidence angle θ=15 degrees, the rotation angle φ=45 degrees, and if the pitch p of the repeated pattern 22=180 nm (line width D_{A} of the line part 2A=90 nm and the duty ratio=1:1), the conditional expression (1) is satisfied when the wavelength λ>350 nm. When the incidence angle θ and the rotation angle φ are the same as those in the above example, and if the pitch p of the repeated pattern 22 is equal to 110 nm (line width D_{A}=55 nm), the conditional expression (1) is satisfied when the wavelength λ>220 nm.

When the incidence angle θ=45 degrees and the rotation angle φ=45 degrees, and if the pitch p of the repeated pattern 22=180 nm (line width D_{A}=90 nm), the conditional expression (1) is satisfied when the wavelength λ>306 nm. When the pitch p of the repeated pattern 22=110 nm (line width D_{A}=55 nm), the conditional expression (1) is satisfied when the wavelength λ>187 nm. Further, not limited to the above specific example, it may also be possible to prevent diffracted light from being emitted from the repeated pattern 22 by selecting a combination of parameters (incidence angle θ, rotation angle φ, wavelength λ, pitch p) that satisfies the conditional expression (1).

The surface-inspecting apparatus 10 in the first embodiment carries out the defect inspection of the repeated pattern 22 by illuminating the repeated pattern 22 on the surface of the specimen 20 with the unpolarized illuminating light L1, by detecting the regular reflected light L2 emitted from the repeated pattern 22 by the light detecting system 14 (FIG. 1), and by basing on the light intensity of the regular reflected light L2.

The direction of the regular reflected light L2 emitted from the repeated pattern 22 is in the incidence plane 3A of the illuminating light L1 and is tilted by the angle θ equal to the incidence angle θ of the illuminating light L1 with respect to the normal (in FIG. 1, the normal 1A at the center of the surface is exemplified) at each point on the surface of the specimen 20.

In order to detect the regular reflected light L2, in the light detecting system 14, an optical axis O35 of the concave reflecting mirror 35 is arranged in a state of being tilted by the angle θ with respect to the normal 1A to the surface of the specimen 20 in the incidence plane 3A. As a result, the regular reflected light L2 from the repeated pattern 22 travels along the optical axis O35 and is guided to the light detecting system 14.

The regular reflected light L2 guided to the light detecting system 14 along the optical axis O35 is caused to condense via the concave reflecting mirror 35 and the image-forming lens 36 and enters the image sensor 37. On this occasion, on the imaging plane of the image sensor 37, a reflected image of the surface of the specimen 20 is formed in accordance with the light intensity of the regular reflected light L2 from each point (the repeated pattern 22) on the surface of the specimen 20. The image sensor 37 is, for example, a CCD image sensor, and it photo-electrically converts the reflected image of the specimen 20 formed on the imaging plane and outputs an image signal (information about the light intensity of the regular reflected light L2) to the image processing unit 15.

Here, the brightness at each point of the reflected image of the specimen 20 is substantially in proportion to the intensity of the regular reflected light L2 emitted from each point (the repeated pattern 22) on the surface of the specimen 20. Further, the intensity of the regular reflected light L2 is substantially in proportion to the magnitude of the reflectance at each point on the surface of the specimen 20. Furthermore, the magnitude of the reflectance at each point varies in accordance with the refractive index at each point.

A relationship between reflectance and refractive index at each point can be generally explained as follows. When light enters in an oblique direction from a transparent medium A to a transparent medium B, the reflectance on the surface of the transparent medium B is an average value of a reflectance Rₚ of the p-polarized light component and a reflectance Rₛ of s-polarized light component of the light. The reflectances Rₚ, Rₛ are expressed by the following expressions (4), (5), where an incidence angle of the light from the transparent medium A to the transparent medium B is θ1 and a refractive index of the light within the transparent medium B is θ2.

Rₚ=(tan(θ1−θ2)/tan(θ1+θ2))² . . . (4)

Rₛ=(sin(θ1−θ2)/sin(θ1+θ2))² . . . (5)

As can be seen from expressions (4), (5), the reflectances Rₚ, Rₛ of the respective polarized light components vary depending on the incidence angle θ1, the refractive index θ2 at the boundary of the media, and therefore, the average value of the reflectances Rₚ, Rₛ (the reflectance on the surface of the transparent medium B) also varies depending on the incidence angle θ1, the refractive angle θ2.

Further, if the refractive indexes of the transparent media A, B are assumed to be n1, n2, the following expression (6) holds between the incidence angle θ1 and refractive angle θ2 according to Snell's law. As a result, the incidence angle θ1 and refractive angle θ2 depend on the refractive indexes n1, n2 of the transparent media A, B.

n1·sin θ1=n2 sin θ2 . . . (6)

It is known therefore that the reflectance (average value of reflectances Rₚ, Rₛ) on the surface of the transparent medium B varies depending on the refractive indexes n1, n2 of the transparent media A, B.

The relationship between the reflectance and refractive index at each point on the surface of the specimen 20 is the same and the reflectance at each point varies depending on the refractive index at each point. Then, the refractive index at each point varies depending on the structure of the repeated pattern 22 (duty ratio and cross sectional shape) at each point, specifically, for example, line width D_{A} of the line part 2A shown in FIG. 3 (or line width D_{B} of the space part 2B).

The change in refractive index when line width D_{A} of the line part 2A of the repeated pattern 22 changes can be explained by a phenomenon called a mechanical birefringence. For simplicity, a case of vertical incidence of illuminating light is explained. In addition, for explanation, the repeated pattern 22 is modeled and it is assumed that a plurality of layers consisting of substance 1 having thickness t₁ and permittivity el and substance 2 having thickness t₂ and permittivity E2 is arranged on a flat plane at a repetition frequency sufficiently short compared to the illumination light wavelength.

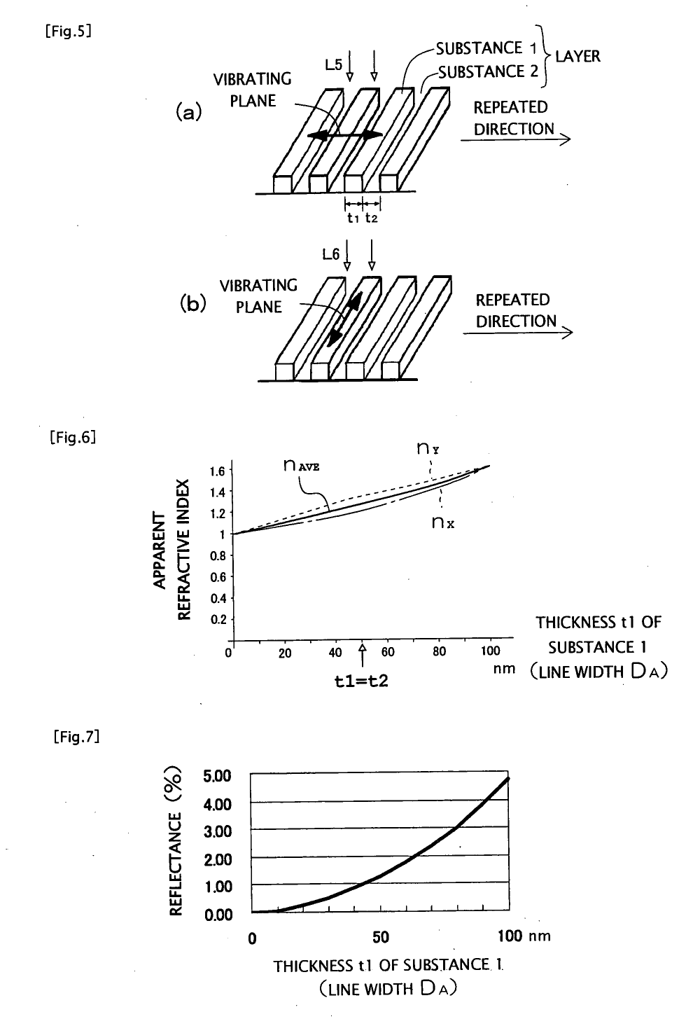

When the repeated pattern (repeated array of layers consisting of substances 1, 2) is irradiated with unpolarized illuminating light, each polarized light included in the illuminating light is split into a linear-polarized component L5 (FIG. 5(a)) in the vibrating plane parallel to the repeated direction of the layers (substances 1, 2) of the repeated pattern and a linear-polarized component L6 (FIG. 5(b) in the vibrating plane vertical to the repeated direction and each of the polarized light components L5, L6 reflects at a reflectance differing from each other in accordance with the mechanical birefringence (a difference between refractive indexes resulting from anisotropy of the repeated pattern).

An electric field is applied to the linear-polarized component L5 shown in FIG. 5(a) in the direction in which the electric field crosses the layers (substances 1, 2) and a small polarization occurs depending on the electric field. When viewed from the electric field, each polarization in each layer aligns in series. On this occasion, the apparent permittivity εₓ can be expressed by the following expression (7). Then, in the case of vertical incidence, the refractive index nₓ of a substance having the permittivity εₓ is expressed by the following expression (8). The refractive index nₓ in expression (8) is a refractive index for the linear-polarized component L5.

[Mathematical Expression 1]

εₓ=(t₁+t₂)ε₁ε₂/(t₁ε₂+t₂ε₁) . . . (7)

nₓ=✓εₓ . . . (8)

In addition, an electric field is applied to the linear-polarized component L6 shown in FIG. 5(b) in the lengthwise direction of the layers (substances 1, 2) and a polarization occurs depending on the electric field. When viewed from the electric field, each polarization in each layer aligns in parallel. On this occasion, the apparent permittivity ε_{Y} is a weighted average of the thickness (t₁+t₂) of layers and can be expressed by the following expression (9). Then, in the case of vertical incidence, the refractive index n_{Y} of a substance having the permittivity ε_{Y} is expressed by the following expression (10). The refractive index ny in expression (10) is a refractive index for the linear-polarized component L6.

[Mathematical Expression 2]

ε_{Y}=(t₁ε₁+t₂ε₂)/(t₁+t₂) . . . (9)

n_{Y}=✓ε_{Y} (10)

Then, refractive index n_{AVE} for the unpolarized illuminating light including the linear-polarized component L5 in FIG. 5(a) and the linear-polarized component L6 in FIG. 5(b) is roughly an average value of refractive index n_{X} (expression (8)) for the linear-polarized component L5 and refractive index n_{Y} (expression (10)) for the linear-polarized component L6 and is expressed by the following expression (11).

n_{AVE}=(n_{X}+n_{Y})/2 . . . (11)

Further, the relationship between refractive index at each point on the surface of the specimen 20 (refractive index n_{AVE} for the above-mentioned unpolarized illuminating light) and thickness t₁ of substance 1 constituting the layers (substances 1, 2) is schematically shown in FIG. 6. In FIG. 6, apparent refractive index n_{X} of the linear-polarized component L5 parallel to the repeated direction of the layers and apparent refractive index n_{Y} of the linear-polarized component L6 vertical to the repeated direction are also shown.

In the calculation in FIG. 6, it is assumed that substance 1 is a resist (permittivity ε₁=2.43), substance 2 is air (permittivity ε₂=1), and thickness (t₁+t₂) of the layer is 100 nm. Thickness (t₁+t₂) of the layer corresponds to pitch p of the repeated pattern 22. In addition, substance 1 corresponds to the line part 2A of the repeated pattern 22 and thickness t₁ of substance 1 corresponds to line width D_{A} of the line part 2A (FIG. 3). Substance 2 corresponds to the space part 2B and thickness t₂ of substance 2 corresponds to line width D_{B} of the space part 2B.

As seen from FIG. 6, the refractive index at each point on the surface of the specimen 20 (refractive index n_{AVE} for the above-mentioned unpolarized illuminating light) changes depending on the thickness t₁ of substance 1 constituting the layer (line width D_{A} of the line part 2A of the repeated pattern 22).

Further, the result of the calculation of the relationship between the reflectance and thickness t₁ of substance 1 (line width D_{A}) at each point on the surface from the relationship between thickness t₁ of substance 1 (line width D_{A}) and the refractive index (n_{AVE}) at each point on the surface of the specimen 20 shown in FIG. 6 is shown in FIG. 7. In FIG. 7, since the reflectance of the surface is shown, the reflectance when the thickness t₁=0 is 0%.

From FIG. 7, it is known that the reflectance at each point on the surface of the specimen 20 also changes depending on thickness t₁ of substance 1 (line width D_{A}). The calculation in FIG. 7 assumes the case where the above-mentioned rotation angle φ (FIG. 4) is not zero degree, and the reflectance is calculated from the apparent refractive index n_{X} of the polarized component L5 parallel to the repeated direction and the apparent refractive index n_{Y} of the polarized component L6 vertical to the repeated direction for each of the p-polarized light component and the s-polarized light component of the incidence light and both are added.

As described above, if an anomaly occurs in the structure of the repeated pattern 22 at each point on the surface of the specimen 20 and line width D_{A} of the line part 2A (or line width D_{B} of the space part 2B) changes, the refractive index (n_{AVE}) at that part changes and as a result, the reflectance also changes.

The change in reflectance at each point on the surface of the specimen 20 tends to increase the reflectance as line width D_{A} of the line part 2A becomes thicker and decrease the reflectance as line width D_{A} becomes thinner as shown in FIG. 7.

Because of this, the light intensity of the regular reflected light L2 emitted from each point on the surface of the specimen 20 increases as line width D_{A} becomes thicker and decreases as line width D_{A} becomes thinner, and the magnitude of the light intensity appears as the brightness of the reflected image of the specimen 20. In other words, the reflected image is brighter at the part where line width D_{A} of the line part 2A is thicker and the reflected image is darker at the part where line width D_{A} is thinner. The brightness of the reflected image appears in each shot area 21 of the specimen 20 (FIG. 2).

In the surface-inspecting apparatus 10 in the present embodiment (FIG. 1), the reflected image of the specimen 20 that reflects the change in line width D_{A} of the line part 2A (change in the structure of the repeated pattern 22) is formed on the imaging plane of the image sensor 37 and information (image signal) about the brightness of the reflected image of the specimen 20 is output from the image sensor 37 to the image processing unit 15. Due to this, in the image processing unit 15, it is possible to detect a defect of the repeated pattern 22 (for example, a change in structure, such as a change in line width D_{A}) based on the image signal from the image sensor 37.

For example, the image of the specimen 20 is taken in based on the image signal from the image sensor 37 and its luminance information is compared with the luminance information of the image of a non-defective wafer. A non-defective wafer is one on which the repeated pattern 22 is formed on the entire surface in an ideal form (for example, the duty ration is 1:1). The luminance of the image of a non-defective wafer is substantially a constant value at the portion where the ideal repeated pattern 22 is formed. In contrast to this, the luminance of the image of the specimen 20 has a value different from another for each shot area 21 (FIG. 2) depending on whether the repeated pattern 22 is normal or anomalous. The image of the specimen 20 is an image of a comparatively wide area (the whole area or part of the area) of the specimen 20 and also called a macro image.

In the image processing unit 15, the image of the specimen 20 is compared with the image of a non-defective wafer, whether the repeated pattern 22 is normal or anomalous is determined based on the luminance difference of the images, and thus a defect of the repeated pattern 22 is detected. For example, when the luminance difference between images is smaller than a predetermined threshold value (permitted value), the repeated pattern 22 is determined to be normal and when the difference is greater than the threshold value, the repeated pattern 22 is determined to be anomalous, and the anomalous portion is detected as a defect. The anomalous portion (defect) is a portion where, for example, line width D_{A} of the line part 2A of the repeated pattern 22 becomes thicker or thinner beyond the design margin.

For the detection of a defect of the repeated pattern 22 by the image processing unit 15, it is also possible to utilize the following method, in addition to the method in which comparison with the image of a non-defective wafer is made. In other words, array data and a threshold value of luminance value of the shot area 21 of the specimen 20 are stored in advance, and the position of each shot area 21 in the image of the specimen 20 that has been taken in is grasped based on the above-mentioned array data, and the luminance value of each shot area 21 is acquired. Then, by comparing the luminance value of each shot area 21 with the prestored threshold value, a defect of the repeated pattern 22 is detected. The shot area 21 where the luminance value is smaller than the threshold value is determined to be a defect.

Further, since the arrangement of the repeated pattern in each shot area 21 of the specimen 20 is the same, it may also be possible to detect a defect by specifying the non-defective shot area 21 and using its luminance value as a reference. It may also be possible to compare the luminance value of the image of the specimen 20 with that of the image of a limit sample. It may also be possible to detect a defect of the repeated pattern 22 by determining a reference of the luminance value by simulation and comparing the luminance value with the reference value. When a non-defective wafer is not used, there is an advantage that it is not necessary to manufacture a dedicated wafer the entire surface of which is non-defective.

As described above, in the surface-inspecting apparatus 10 in the present embodiment, when the defect inspection of the repeated pattern 22 is carried out based on the light intensity of the regular reflected light L2 emitted from the repeated pattern 22 when the repeated pattern 22 on the surface of the specimen 20 is illuminated, the above-rotation angle φ (FIG. 4) is set obliquely and at the same time, each part is set so that the rotation angle φ, the incidence angle θ and the wavelength λ of the illuminating light L1, and the pitch p of the repeated pattern 22 can satisfy the conditional expression (1).

If such a setting is made, it is unlikely that the diffracted light is emitted from the repeated pattern 22 on the surface of the specimen 20 and when a repeated pattern with a pitch about the same as that of the repeated pattern 22 is formed in the base layer, it is also unlikely that the similar diffracted light is emitted from the repeated pattern in the base layer. Because of this, it is unlikely that the diffracted light (noise light) from the repeated pattern 22 on the surface and the diffracted light (noise light) from the repeated pattern in the base layer mix with the regular reflected light L2 (signal light) emitted from the repeated pattern 22 on the surface.

The contrast of the diffracted light from the base layer is high and if the diffracted light from the base layer mixes as noise light, the change in the regular reflected light L2 (signal light) from the surface to be inspected becomes difficult to detect because its change is hidden by the change in contrast due to the diffracted light component.

However, in the surface-inspecting apparatus 10 in the present embodiment, it is unlikely that the diffracted light from the base layer (and the diffracted light from the surface) mixes with the regular reflected light L2 (signal light) as noise light due to the setting described above, and therefore, it becomes relatively easier to grasp the change in the regular reflected light L2 (signal light).

The regular reflected light L2 (signal light) from the surface is mixed with the regular reflected light from the base layer as noise light. However, its ratio (ratio of signal light to noise light) is considerably smaller than that in the case of the conventional defect inspection using the diffracted light. In other words, in the case of the defect inspection using the regular reflected light according to the present invention, it is possible to considerably reduce the ratio of noise light to signal light compared to the case of the conventional defect inspection using diffracted light.

As a result, according to the surface-inspecting apparatus 10 in the present embodiment, it is possible to successfully carry out the defect inspection of the repeated pattern 22 on the surface, with the influence of the base layer being reduced by utilizing the regular reflected light emitted from the specimen 20 (most of the regular reflected light is the regular reflected light L2 emitted from the repeated pattern 22 on the surface to be inspected).

In addition, in the conventional defect inspection using diffracted light, it is not possible in principle to carry out the defect inspection if the pitch of the repeated pattern is smaller than a predetermined value (=(diffraction order)×(wavelength of illuminating light)/2) because no diffracted light is emitted. Further, even when the repetition pitch is in the vicinity of the predetermined value, it is difficult to carry out the defect inspection using the diffracted light because the arrangement of the illuminating system and the light detecting system in the apparatus is restricted. In order to deal with the shift to the smaller repetition pitches, it is required to shorten the wavelength of the illuminating light and the above-mentioned predetermined value, however, this is not preferable because the kind of the light source is limited to those which are expensive and large-scaled and the materials of the optical elements that constitute the illuminating system and the light detecting system are also limited to expensive ones.

In contrast to this, in the surface-inspecting apparatus 10 in the present embodiment, since the defect inspection of the repeated pattern 22 is carried out using the regular reflected light (the regular reflected light L2 mainly from the surface) from the specimen 20, there are not such restrictions described above, and it is also possible to deal with the shift to the smaller repetition pitches. In other words, even when the pitch p of the repeated pattern 22 is sufficiently small compared to the wavelength λ, it is possible to carry out the defect inspection successfully. It is obvious, however, that the defect inspection of the repeated pattern 22 can be carried out even when the pitch p is about the same as the wavelength λ or the pitch p is larger than the wavelength λ, not limited to the case where the pitch p is sufficiently small compared to the wavelength λ. In other words, regardless of the pitch p of the repeated pattern 22, it is possible to carry out the defect inspection without fail.

In the surface-inspecting apparatus 10 in the present embodiment, even when the pitch p of the repeated pattern 22 of the specimen 20 is different, it is possible to carry out the defect inspection while keeping the specimen 20 in a horizontal state (without making the tilt adjustment of the stage 11). Due to this, it is possible to securely shorten the preparation time before the actual defect inspection starts (that is, the image of the specimen 20 is taken in) and therefore the working efficiency is increased.

Further, in the surface-inspecting apparatus 10 in the present embodiment, since the stage 11 is not provided with the tilting mechanism, the configuration of the apparatus can be simplified. In addition, it is possible to use an inexpensive radial light source as the light source 31 in the illuminating system 13 and therefore the entire configuration of the surface-inspecting apparatus 10 can be simplified and realized at a low cost.

Furthermore, in the surface-inspecting apparatus 10 in the present embodiment, even when a plurality of kinds of repeated pattern are formed on the surface of the specimen 20 and repeated patterns different in the pitch p and the repeated direction (X direction) exist mixedly, it is possible to carry out the defect inspection of all of the repeated patterns with ease by taking in the reflected images of the surface of the specimen 20 altogether.

For example, the two kinds of repeated pattern different in the repeated direction are the repeated pattern in the zero-degree direction and the repeated pattern in the 90-degree direction. The repeated directions of these repeated patterns are perpendicular to each other. In this case, if the above-mentioned rotation angle φ (FIG. 4) is set to 45 degrees, the condition of the defect inspection of each repeated pattern can be made common and it is possible to carry out each defect inspection both simultaneously and successfully.

In the surface-inspecting apparatus 10 in the present embodiment, even when the ideal duty ratio is other than 1:1, not limited to the case where the designed value of line width D_{A} of the line part 2A of the repeated pattern 22 is half the pitch p (the ideal duty ratio between the line part 2A and the space part 2B is 1:1), it is similarly possible to carry out the defect inspection successfully. In this case, there may be the case where the luminance value of the reflected image of the specimen 20 increases depending on the change in the shape of the repeated pattern 22.

As to the wavelength λ of the illuminating light L1, it is only required to adequately select it by changing the wavelength-selective filter 32 so as to satisfy the above-mentioned conditional expression (1) together with the rotation angle φ, the incidence angle θ, and the pitch p, however, it is further preferable to select a wavelength included in the absorption band of the anti-reflection coating (ARC) of the specimen 20. In this case, since the amount of light that reaches the base layer decreases because of the absorption by the anti-reflection coating, it will be advantageous in separating the surface from the base layer. It is possible to select such a wavelength λ by reading information about the wavelength λ from the inspection recipe and changing the wavelength-selective filter 32.

### Second Embodiment

An example is described here, in which the illuminating light L1 includes a plurality of different wavelengths. The plurality of wavelengths may include discrete wavelengths, such as a plurality of bright-line spectra, or continuous wavelengths, such as those in a broad wavelength band. In the following description, it is assumed that the illuminating light L1 includes a plurality of bright-line spectra of different wavelengths.

Each wavelength λ of the plurality of bright-line spectra may be adequately selected by changing the wavelength-selective filter 32 so as to satisfy the conditional expression (1) together with the rotation angle φ, the incidence angle θ, and the pitch p, similar to the above, and it is further preferable to select a wavelength included in the absorption band of the anti-reflection coating of the specimen 20.

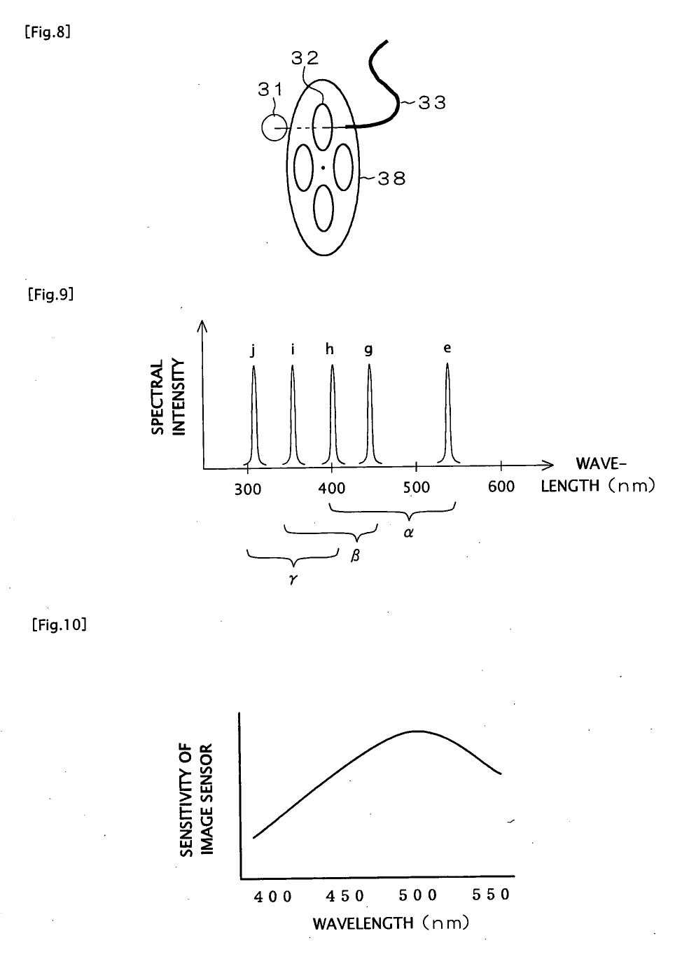

As a changing mechanism of the wavelength-selective filter 32, such a configuration may be one of candidates, as shown in FIG. 8, in which a plurality of wavelength-selective filters 32 having different passbands are attached to a disk-like turret 38 and the turret 38 is rotated by a driving mechanism, such as a motor, not shown.

For example, when the light from the light source 31 includes many bright-line spectra (including the e-ray etc.) as shown in FIG. 9, if the wavelength-selective filter 32 having a passband α is arranged on the light path, it selectively transmits the three bright-line spectra, that is, the e-ray (546 nm), the g-ray (436 nm), and the h-ray (405 nm) and irradiates the specimen 20 with them as the illuminating light L1. If the wavelength-selective filter 32 having a passband α is replaced by the wavelength-selective filter 32 having a passband β, it selectively transmits the three bright-line spectra, that is, the g-ray, the h-ray, and the i-ray (365 nm), and if the wavelength-selective filter 32 having a passband α is replaced with the wavelength-selective filter 32 having a passband γ, it selectively transmits the three bright-line spectra, that is, the h-ray, the i-ray, and the j-ray (313 nm) and irradiates the specimen 20 with them.

Then, when the illuminating light L1 includes a plurality of bright-line spectra, the regular reflected light L2 is emitted from the specimen 20 due to the bright-line spectrum of each wavelength λ, and the light intensity of the regular reflected light L2 of each wavelength λ is coupled on the imaging surface of the image sensor 37. In addition, the image signal output from the image sensor 37 to the image processing unit 15 serves as information about the light intensity after the coupling of the regular reflected light L2 of each wavelength λ. In this case, the image processing unit 15 carries out the defect inspection of the repeated pattern 22 based on the light intensity after the coupling as a result.

When there is film-thickness unevenness in the base layer of the specimen 20, if the interference fringe that reflects the film-thickness unevenness (the pattern of brightness due to the interference in the base layer) overlaps the reflected image by the regular reflected light L2 (signal light) from the surface to be inspected, it becomes difficult to detect a defect of the repeated pattern 22 on the surface. When the illuminating light L1 has a single wavelength, if the interference fringe that reflects the film-thickness unevenness in the base layer occurs, the interference fringe overlaps the reflected image of the surface and it is no longer possible to carry out the defect inspection successfully.

However, in the surface-inspecting apparatus in the present embodiment, since the illuminating light L1 includes a plurality of bright-line spectra, even if the interference fringe that reflects the film-thickness unevenness in the base layer occurs, the state (shape) of the interference fringe differs for each wavelength λ, and the light intensity of the interference fringe of each wavelength λ is coupled and the pattern of brightness is canceled out. Because of this, it is possible to reduce the contrast of the final interference fringe that overlaps the reflected image of the surface. In other words, it is possible to reduce the influence of the interference fringe that reflects the film-thickness unevenness in the base layer.

As described above, even when there is film-thickness unevenness in the base layer, it is possible to reduce the influence of the film-thickness unevenness and carry out the defect inspection of the repeated pattern 22 on the surface successfully by illuminating the specimen 20 with the illuminating light L1 including a plurality of bright-line spectra. The same effect can be obtained when the plurality of wavelengths included in the illuminating light L1 are continuous, not limited when discrete.

Since the influence of the film-thickness unevenness in the base layer can be reduced, it will also be useful for the defect inspection in the process in which the portion where the repeated pattern 22 is formed is small in area (the area of the portion where the base layer exposes is large) in each shot area 21 (FIG. 2) of the specimen 20.

In addition, the sensitivity of the image sensor 37 generally differs for each wavelength λ and, for example, as shown in FIG. 10, the sensitivity is highest for the wavelength near 500 nm and the sensitivity decreases toward shorter wavelengths or longer wavelengths. FIG. 10 shows the sensitivity in a range between 400 to 550 nm as an example. By adjusting the light intensity of each wavelength of the illuminating light Li in accordance with the wavelength characteristic of the sensitivity of the image sensor 37 such as described above, it is possible to effectively reduce the influence of the film-thickness unevenness in the base layer.

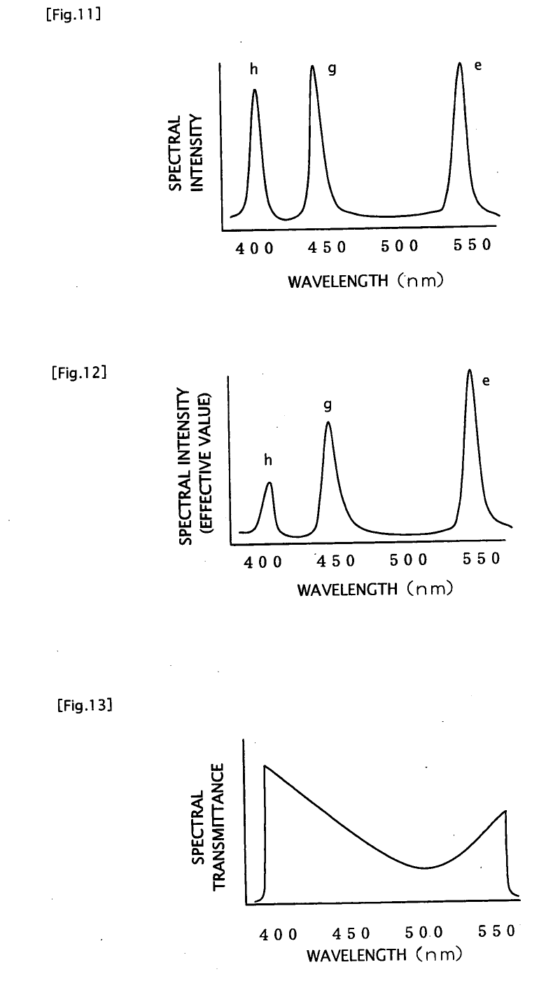

The adjustment of the light intensity of each wavelength of the illuminating light L1 is explained here using the bright-line spectra (e-ray, g-ray, h-ray in FIG. 9) included in the range of wavelength in FIG. 10 among the light from the light source 31 as an example. When the wavelength-selective filter 32 selectively transmits the e-ray, the g-ray, and the h-ray, if the spectral transmittance in the passband α of the wavelength-selective filter 32 is constant, the spectral intensity of the e-ray, the g-ray, and the h-ray included in the illuminating light L1 is, for example, as that shown in FIG. 11.

In this case, the spectral intensity of each wavelength λ (e-ray, g-ray, h-ray) of the regular reflected light L2 emitted from the specimen 20 when irradiated with the illuminating light L1 is the same as that in FIG. 11, however, if this is detected by the image sensor 37 having the sensitivity characteristic shown in FIG. 10, the spectral intensity of the e-ray, the g-ray, and the h-ray after the detection of light (hereinafter, referred to as the “effective intensity”) decreases on the side of shorter wavelengths as shown in FIG. 12. Due to this, the interference fringe of each wavelength λ that reflects the film-thickness unevenness in the base layer does not cancel out each other sufficiently on the side of shorter wavelengths.

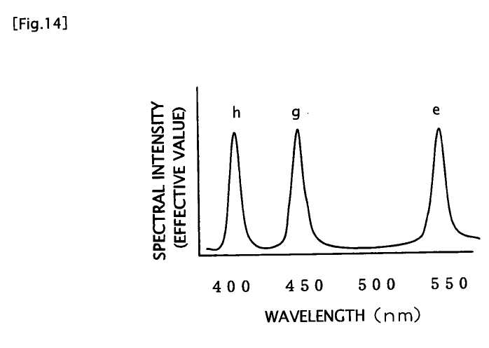

Because of this, the wavelength characteristic of the sensitivity of the image sensor 37 (FIG. 10) being taken into consideration, the spectral transmittance in the passband α of the wavelength-selective filter 32 is set so that it is low near 500 nm and higher on the side of shorter wavelengths and on the side of longer wavelengths. In this case, the light intensity of each wavelength λ (e-ray, g-ray, h-ray) of the illuminating light L1 is adjusted in accordance with the spectral transmittance of the wavelength-selective filter 32 (FIG. 13) and it is possible to maintain the effective intensity constant after the detection of light by the image sensor 37 for each wavelength λ (e-ray, g-ray, h-ray) as shown in FIG. 14.

Consequently, it is possible to sufficiently cancel out the interference fringe of each wavelength λ that reflects the film-thickness unevenness in the base layer and effectively reduce the influence of the film-thickness unevenness in the base layer. If the effective intensity after the detection of light by the image sensor 37 is set constant for each wavelength λ, it is possible to reduce the influence of the film-thickness unevenness in the base layer most effectively, however, the present invention is not limited to this. Even if the effective intensity after the detection of light is not constant for each wavelength λ, it is possible to enhance the effect in reduction of the influence of the film-thickness unevenness in the base layer by adjusting the light intensity of each wavelength λ of the illuminating light L1 so as to correct the wavelength characteristic of the sensitivity of the image sensor 37.

By the way, the wavelength band selected by the wavelength-selective filter 32 (FIG. 9) is not limited to the wavelength bands α, β, and γ described above. Light in a wavelength band shorter than the j-ray (for example, 240 nm to 313 nm), or light in a wavelength band longer than the e-ray may be used as long as its wavelength does not emit diffracted light from the surface of the specimen 20 or the base layer (the wavelength satisfies the conditional expression (1)). In addition, the number of wavelengths included in the illuminating light L1 is not limited to three, and it may be two or four or more.

(Variation)

In the above-mentioned embodiments, the specimen 20 is illuminated with the unpolarized illuminating light L1, however, the present invention is not limited to those. Illumination by polarized light (for example, linear-polarized light) may be acceptable as long as its wavelength does not emit diffracted light from the surface of the specimen 20 or the base layer (the wavelength satisfies the conditional expression (1)). In this case, it is only required to arrange a polarizing plate on the light path in the illuminating system 13 and/or the light detecting system 15 so that it can be removed and reinserted and extract predetermined polarized components. When a polarizing plate is inserted both in the illuminating system 13 and in the light detecting system 15, it is preferable to arrange them so that the transmission axis of each polarizing plate is perpendicular to each other (a so-called crossed Nicols arrangement).

When inspecting a defect using the regular reflected light L2, if the specimen 20 is illuminated with polarized light (for example, linear-polarized light), it is possible to increase the reflectance on the surface and reduce the influence of the base layer all the more. When the specimen 20 is illuminated with linear-polarized light, it is preferable to set the above-mentioned rotation angle θ (FIG. 4) to 45 degrees, and thus the sensitivity of the defect inspection can be increased. As linear-polarized light, p-polarized light or s-polarized light may be acceptable, however, in order to grasp a change only in the surface, it is preferable to illuminate with s-polarized light. In addition, in order to grasp a change including that in the internal structure of the pattern, it is preferable to illuminate with p-polarized light. Since the reflectance and the transmittance of the p-polarized light and the s-polarized light with respect to the surface of the specimen 20 are different, it is made possible to grasp the change only in the surface or grasp the change including that in the internal structure.

In the above-mentioned embodiments, an example is used in explanation, in which the stage 11 is not provided with the tilting mechanism, however, the present invention is not limited to those. It may also be possible to set so that the stage 11 (specimen 20) can rotate around the axis (tilt axis) perpendicular to the incidence plane 3A (FIG. 4) and included in the surface of the specimen 20.

Further, at least two of the illuminating system 13, the light detecting system 14, and the specimen 20 may be rotated around the above-mentioned tilt axes, respectively. With such a configuration, it is possible to vary the incidence angle θ of the illuminating light L1 with respect to the specimen 20 and it is also possible to make it easier to grasp the change in the surface of the specimen 20 because the reflectance changes depending on the change of the incidence angle θ.

In the above-mentioned embodiments, the two-dimensional sensor, such as a CCD, is used as the image sensor 37, however, a one-dimensional sensor may be used. In this case, it is only required to relatively move a one-dimensional sensor, which is an image sensor, and a stage on which the one-dimensional sensor and a semiconductor wafer (or liquid crystal substrate), which is a specimen, are mounted and take in an image of the entire surface thereof by causing the one-dimensional sensor to scan the entire surface of the semiconductor wafer (or liquid crystal substrate).

1. A surface-inspecting apparatus, comprising:
an irradiating unit that irradiates a repeated pattern formed on a surface of a specimen with illuminating light;
a setting unit that sets an angle formed by a direction on said surface of an incidence plane including an irradiating direction of said illuminating light and a normal to said surface and a repeated direction of said repeated pattern to a predetermined value other than zero;
a light detecting unit that detects regular reflected light generated from said repeated pattern when said illuminating light is irradiated and outputs information about light intensity of the regular reflected light; and
a detecting unit that detects a defect of said repeated pattern based on information about the light intensity of said regular reflected light, output from said light detecting unit,
wherein an angle φ formed by the direction on said surface of said incidence plane and said repeated direction, an angle θ formed by the irradiating direction of said illuminating light and the normal to said surface, a wavelength λ of said illuminating light, and a pitch p of said repeated pattern satisfy the following conditional expression
λ/[2 cos(θ·sin φ)]>p.

2. The surface-inspecting apparatus according to claim 1, wherein said illuminating light includes light having a plurality of different wavelengths.

3. The surface-inspecting apparatus according to claim 2, further comprising
an adjusting unit that adjusts the light intensity of each wavelength of said illuminating light in accordance with a wavelength characteristic of a sensitivity of said light detecting unit.

4. The surface-inspecting apparatus according to claim 1, further comprising
an extracting unit arranged on at least one of light paths of said irradiating unit and said light detecting unit to extract a predetermined polarized component.

5. The surface-inspecting apparatus according to claim 1, further comprising
a first rotating unit that rotates said specimen around an axis perpendicular to said surface.

6. The surface-inspecting apparatus according to claim 1, further comprising
a second rotating unit that rotates at least two of said light irradiating unit, said light detecting unit, and said specimen around an axis perpendicular to said incidence plane and included in said surface.

7. A surface-inspecting method that irradiates a repeated pattern formed on a surface of a specimen with illuminating light, detects regular reflected light generated from said repeated pattern when the illuminating light is irradiated, and detects a defect of said repeated pattern based on information about light intensity of the regular reflected light,
wherein: an angle formed by a direction on said surface of an incidence plane including the irradiating direction of said illuminating light and a normal to said surface and the repeated direction of said repeated pattern is set to a predetermined value other than zero; and
an angle φ formed by the direction on said surface of said incidence plane and said repeated direction, an angle θ formed by an irradiating direction of said illuminating light and a normal to said surface, a wavelength λ of said illuminating light, and a pitch p of said repeated pattern satisfy the following conditional expression
λ/[2 cos(θ·sin φ)]>p.
